(19) United States
(12) Patent Application Publication
(10) Pub. No.: US 2026/0085829 A1
(43) Pub. Date: Mar. 26, 2026

(54) ILLUMINATION DEVICE AND LENS MODULE

(71) Applicant: Japan Display Inc., Tokyo (JP)

(72) Inventor: Daisuke HAMANO, Tokyo (JP)

(21) Appl. No.: 19/404,697

(22) Filed: Dec. 1, 2025

Related U.S. Application Data
(63) Continuation of application No. PCT/JP2024/015088, filed on Apr. 16, 2024.

(30) Foreign Application Priority Data
Jun. 2, 2023 (JP) 2023-091535

(51) Int. Cl. F21V 23/06; F21V 5/04; F21V 9/40; F21V 23/00; F21Y 115/10

(52) U.S. Cl. CPC F21V 23/06; F21V 5/04; F21V 9/40; F21V 23/001; F21Y 2115/10

(57) ABSTRACT

According to an aspect, an illumination device includes: a holding member having a center axis extending in a first direction; a held member supporting the holding member to allow the holding member to rotate about the center axis; a lens module mounted on the holding member; a relay substrate mounted on the holding member and electrically coupled to the lens module through a wire harness; a light source mounted on the held member; and a control substrate. The lens module includes a panel unit in which liquid crystal panels are stacked in the first direction and a conductive member provided on a side surface of the panel unit and extending in the first direction. The wire harness is electrically coupled to an elastic member having conductivity. The elastic member is in contact with the conductive member so that the elastic member is electrically coupled to the conductive member.

### CROSS-REFERENCE TO RELATED APPLICATIONS

This application claims the benefit of priority from Japanese Patent Application No. 2023-091535 filed on Jun. 2, 2023 and International Patent Application No. PCT/JP2024/015088 filed on Apr. 16, 2024, the entire contents of which are incorporated herein by reference.

### BACKGROUND

### 1. Technical Field

What is disclosed herein relates to an illumination device and a lens module.

### 2. Description of the Related Art

An illumination device including a light source such as an LED is publicly known (refer to Japanese Patent Application Laid-open Publication No. 2013-48029 (JP-A-2013-48029), for example). The illumination device of JP-A-2013-48029 is an LED lamp including a base, an LED (light source), and a tubular member coupling the base and the LED. The tubular member is flexible, which allows the orientation of the LED relative to the base to be changed by bending the tubular member relative to the axial direction.

In a case where the shape (light distribution pattern) of emission light from an illumination device is not a circular shape centered at the optical axis (for example, the shape is elongated in one direction), the illumination device is desired to be capable of rotating the light distribution pattern about the axial center.

Such an illumination device includes, for example, a first tubular member, a second tubular member rotatably supporting the first tubular member, a plurality of liquid crystal panels fixed to the first tubular member, a control substrate fixed to the second tubular member and configured to control the liquid crystal panels, and wires electrically coupling the liquid crystal panels and the control substrate.

However, when the first tubular member to which the liquid crystal panels are fixed is rotated relative to the second tubular member to which the control substrate is fixed, the wires are twisted, and coupling portions between the wires and the liquid crystal panel is potentially damaged.

### SUMMARY

According to an aspect, an illumination device includes: a holding member having a center axis extending in a first direction; a held member supporting the holding member so as to allow the holding member to rotate in a direction about the center axis; a lens module mounted on the holding member and including a plurality of liquid crystal panels; a relay substrate mounted on the holding member and electrically coupled to the lens module through a wire harness; a light source mounted on the held member; and a control substrate mounted on the held member and electrically coupled to the relay substrate. The lens module includes a panel unit in which the liquid crystal panels are stacked in the first direction, and a conductive member provided on a side surface of the panel unit and extending in the first direction. The wire harness is electrically coupled to an elastic member having conductivity. The elastic member is in contact with the conductive member so that the elastic member and the conductive member are electrically coupled to each other.

According to an aspect, a lens module includes: a panel unit in which a plurality of liquid crystal panels are stacked in a first direction; and a conductive member provided on a side surface of the panel unit and extending in the first direction. An elastic member electrically coupled to a wire harness and having conductivity is in contact with the conductive member.

### BRIEF DESCRIPTION OF THE DRAWINGS

FIG. 1 is a schematic sectional view of the illumination device according to a first embodiment;

FIG. 2 is a front view of a lens unit;

FIG. 3 is a side view of the lens unit;

FIG. 4 is a back view of the lens unit;

FIG. 5 is a perspective view of the lens unit;

FIG. 6 is an exploded perspective view of the lens unit;

FIG. 7 is a plan view of a lens module;

FIG. 8 is a sectional view of the lens module;

FIG. 9 is a plan view of a lower substrate of a liquid crystal panel;

FIG. 10 is a plan view of an upper substrate of the liquid crystal panel;

FIG. 11 is a schematic diagram illustrating the orientations of the lower and upper substrates of the liquid crystal panels constituting a panel unit in a plan view;

FIG. 12 is a plan view illustrating the lens module, metal plates, and wire harnesses;

FIG. 13 is a side view of FIG. 12;

FIG. 14 is an enlarged schematic diagram of part A in FIG. 13;

FIG. 15 is a schematic diagram illustrating a metal plate and a conductive member in a first modification;

FIG. 16 is a schematic diagram illustrating a metal plate and a conductive member in a second modification;

FIG. 17 is a perspective view of a lens module according to a second embodiment; and

FIG. 18 is a sectional view of FIG. 17.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

### First Embodiment

First, an illumination device according to a first embodiment will be described below.

### Configuration of Illumination Device

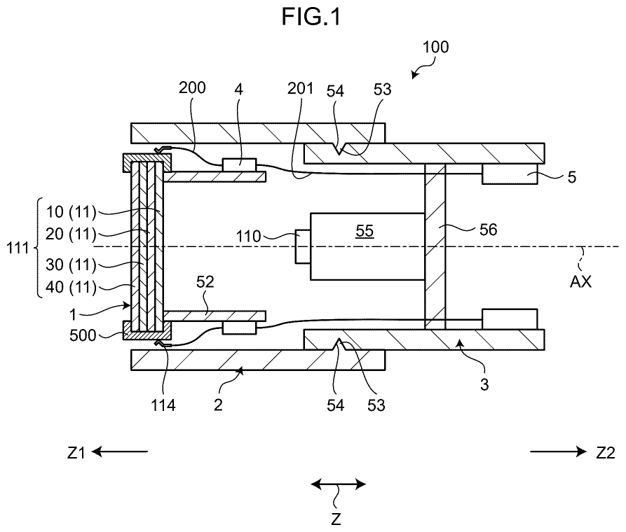

FIG. 1 is a schematic sectional view of the illumination device according to the first embodiment. As illustrated in FIG. 1, an illumination device 100 according to the first embodiment includes a lens module 1, a holding member 2, a held member 3, relay substrates 4, control substrates 5, wire harnesses 200 and 201, and an LED (light source) 110.

The holding member 2 is a tubular member having a center axis AX. The holding member 2 rotates in a direction about the center axis AX relative to the held member 3. Accordingly, the lens module 1 rotates in the direction about the center axis AX. The center axis AX extends in a Z direction (axial direction or first direction). In other words, the axial direction of the center axis AX is the same direction as the Z direction and the first direction. A protrusion 53 protrudes inward in the radial direction from the inner periphery of the holding member 2. The protrusion 53 is formed in a ring shape that is continuous across the entire inner periphery of the holding member 2.

The held member 3 is a tubular member having the center axis AX. A distal end part of the held member 3 is fitted to the inner periphery of the holding member 2. A recessed groove 54 that is recessed inward in the radial direction is provided at the outer periphery of the held member 3. The protrusion 53 of the holding member 2 is fitted to the recessed groove 54. With this configuration, the holding member 2 rotates in the direction about the center axis AX relative to the held member 3.

The lens module 1, the wire harnesses 200, and the relay substrates 4 are provided on the holding member 2. The lens module 1 is disposed on the inner peripheral side of a Z1-side end portion of the holding member 2. The lens module 1 includes, for example, a plurality of liquid crystal panels 11. The liquid crystal panels 11 include, for example, a first liquid crystal panel 10, a second liquid crystal panel 20, a third liquid crystal panel 30, and a fourth liquid crystal panel 40.

As illustrated in FIG. 1, the lens module 1 includes a panel unit 111. The panel unit 111 is formed by stacking the liquid crystal panels 11. In the present embodiment, the liquid crystal panels 11 are, for example, the first liquid crystal panel 10, the second liquid crystal panel 20, the third liquid crystal panel 30, the fourth liquid crystal panel 40. Specifically, in the panel unit 111, the first liquid crystal panel 10, the second liquid crystal panel 20, the third liquid crystal panel 30, and the fourth liquid crystal panel 40 are stacked in the axial direction in this order from the side closer to the LED 110. In the illumination device 100 according to the present embodiment, liquid crystal panels for p-wave polarization and liquid crystal panels for s-wave polarization are stacked and combined.

The relay substrates 4 are attached to the outer peripheral surface of a tubular member 52. The wire harnesses 200 extend in the Z direction. The relay substrates 4 are electrically coupled to the lens module 1 through the wire harnesses 200. Specifically, metal plates 114 (elastic members) are in contact with conductive members 500 in the lens module 1, and the wire harnesses 200 are coupled to the metal plates 114. The metal plates 114 and the conductive members 500 will be described later in detail.

The control substrates 5, the LED 110, and the wire harnesses 201 are mounted on the held member 3. The control substrates 5 are attached to the inner periphery of a Z2-side end portion of the held member 3. The control substrates 5 control each liquid crystal panel 11 in the lens module 1.

As illustrated in FIG. 1, the wire harnesses 201 electrically couple the relay substrates 4 and the control substrates 5. The wire harnesses 201 extend in the Z direction. The lengths of the wire harnesses 200 are shorter than the lengths of the wire harnesses 201. As described above, the holding member 2 rotates relative to the held member 3. The wire harnesses 201 are slack when the rotation angle of the holding member 2 relative to the held member 3 is 0°. The wire harnesses 201 are still slack and have excess length when the rotation angle of the holding member 2 relative to the held member 3 is 45°, 90°, or even 360° (in a state in which the holding member 2 has made one complete rotation relative to the held member 3). As illustrated in FIG. 1, a heat sink 55 is attached to the inner periphery of the held member 3 with an attachment member 56 therebetween. The LED 110 is fixed to the Z1 side of the heat sink 55. In other words, the LED 110 is fixed to the held member 3 with the heat sink 55 and the attachment member 56 therebetween.

### Configuration of Lens Unit

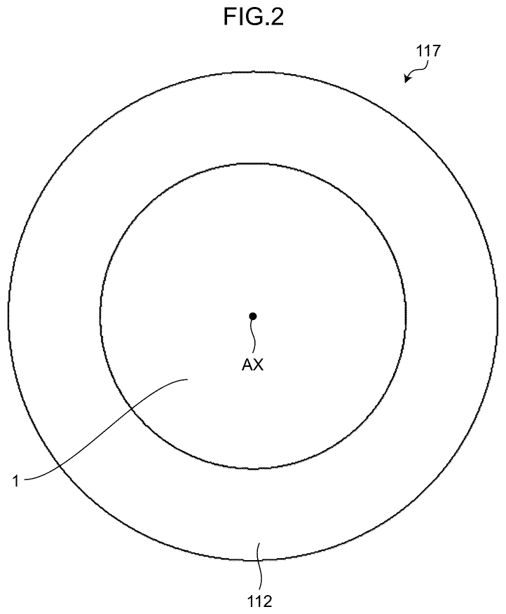

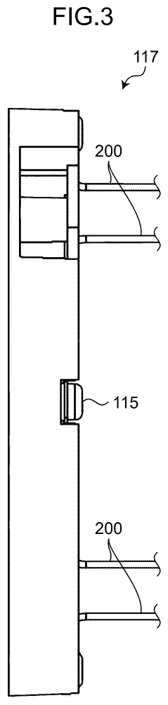

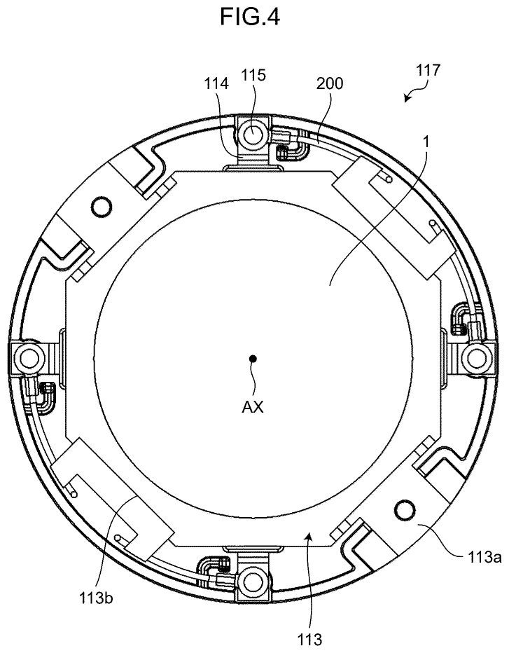

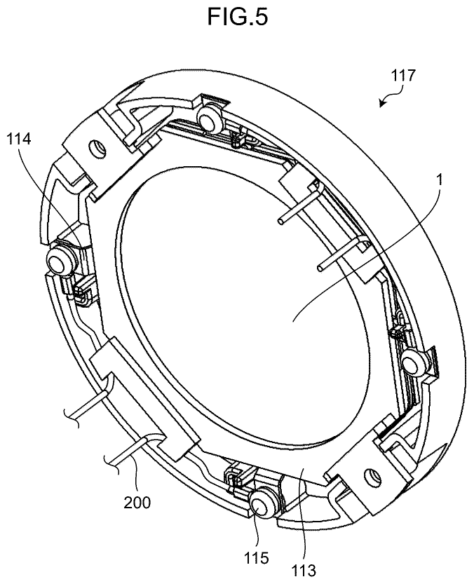

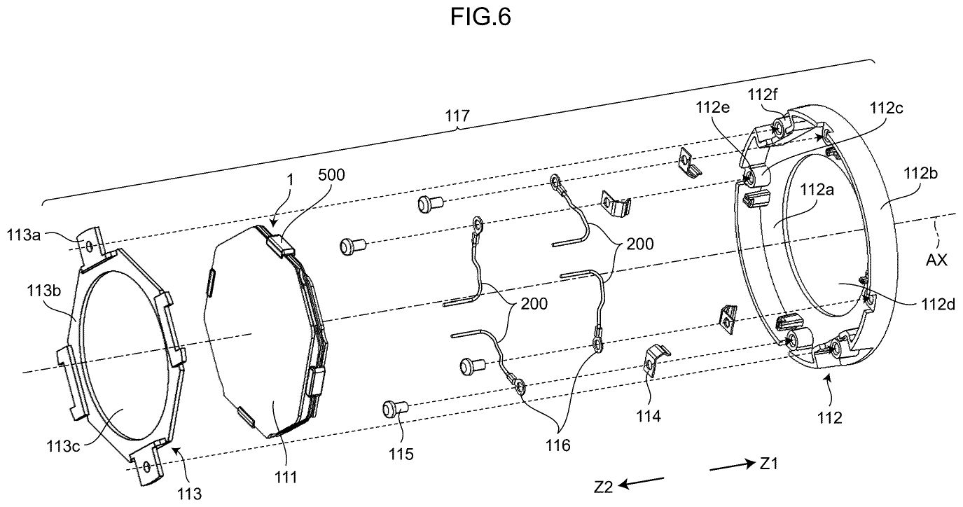

FIG. 2 is a front view of a lens unit. FIG. 3 is a side view of the lens unit. FIG. 4 is a back view of the lens unit. FIG. 5 is a perspective view of the lens unit. FIG. 6 is an exploded perspective view of the lens unit.

As illustrated in FIGS. 2 to 6, a lens unit 117 includes the lens module 1, a frame 112, and an attachment member 113.

As illustrated in FIGS. 2 to 6, the frame 112 houses the lens module 1. The frame 112 includes a bottom surface portion 112a and a side surface portion 112b. As illustrated in FIG. 6, the bottom surface portion 112a has an annular shape (ring shape) centered at the center axis AX, and an opening 112d is provided at the center of the bottom surface portion 112a. Four bosses 112c are provided at the bottom surface portion 112a. Each boss 112c is provided with a recessed portion 112e. A metal plate (elastic member) 114 and a clasp 116 are attached to the boss 112c with a pin 115. Specifically, the metal plate 114 is placed at a top portion of the boss 112c, the clasp 116 is placed on the metal plate 114, and in this state, the pin 115 is inserted into a through-hole of the metal plate 114 and a through-hole of the clasp 116 and fitted into the recessed portion 112e. Accordingly, each of the four bosses 112c is provided with the metal plate 114 and the clasp 116. The side surface portion 112b extends from the outer periphery of the bottom surface portion 112a to the Z2 side. The side surface portion 112b is tubular. The four bosses 112c are provided on the inner peripheral surface of the side surface portion 112b.

As illustrated in FIG. 6, the attachment member 113 includes a body portion 113b and an attachment portion 113a. A circular opening 113c is provided in the central portion of the body portion 113b. The body portion 113b is ring-shaped. Two of the attachment portions 113a are provided and protrude outward in the radial direction from the body portion 113b. The attachment portions 113a of the attachment member 113 are fixed to attachment portions 112f of the frame 112 with non-illustrated bolts. In other words, in a state in which the lens module 1 is housed in the frame 112, the attachment portions 113a of the attachment member 113 are fixed to the attachment portions 112f of the frame 112 with non-illustrated bolts, and accordingly, the lens module 1 is supported by the frame 112 and the attachment member 113. In this manner, the lens unit 117 is assembled.

### Configuration of Lens Module

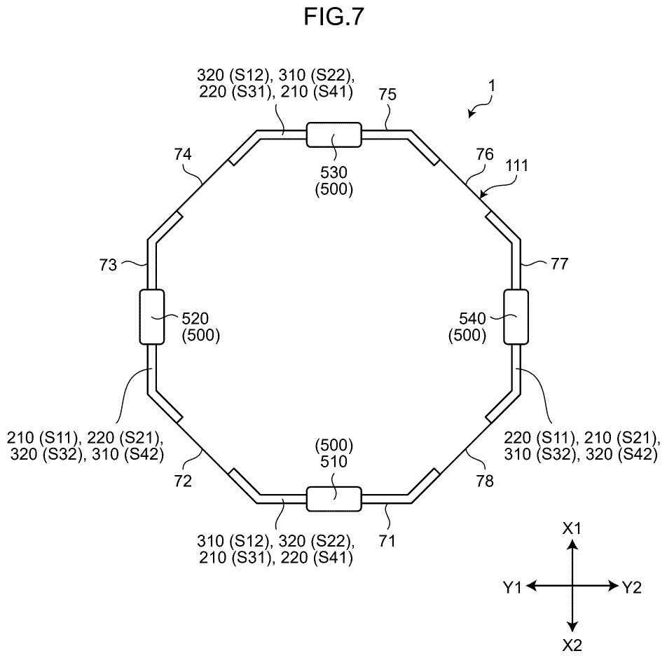

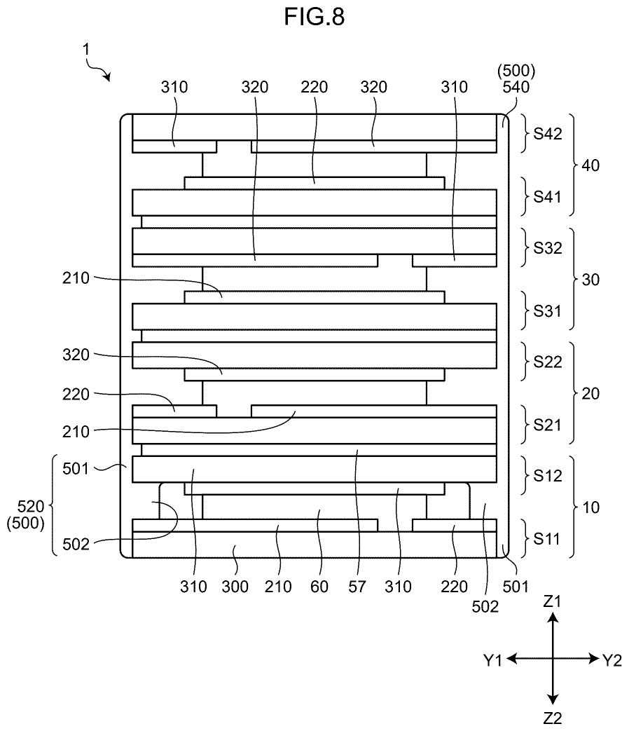

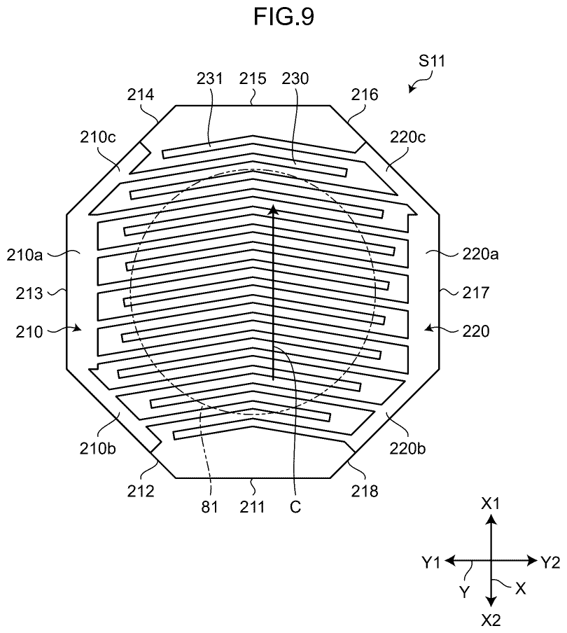

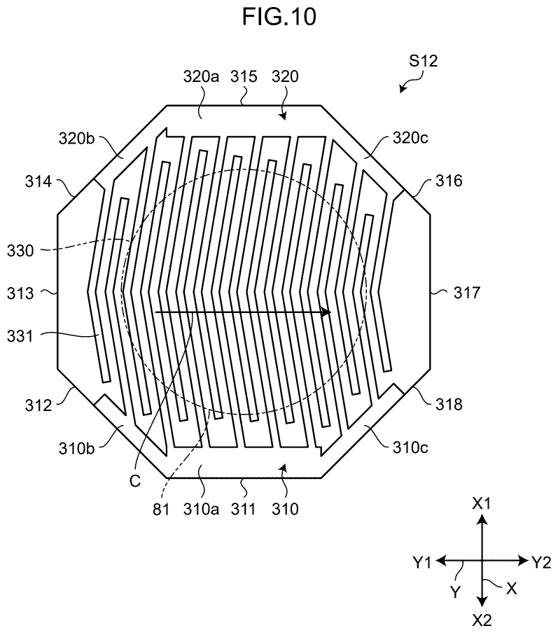

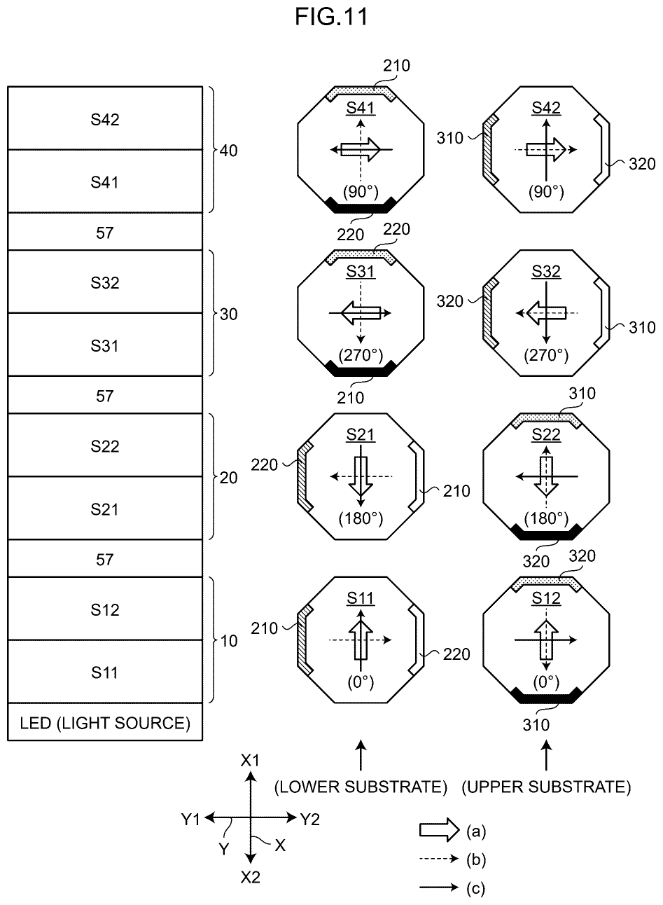

FIG. 7 is a plan view of the lens module. FIG. 8 is a sectional view of the lens module. FIG. 9 is a plan view of a lower substrate of a liquid crystal panel. FIG. 10 is a plan view of an upper substrate of the liquid crystal panel. FIG. 11 is a schematic diagram illustrating the orientations of the lower and upper substrates of the liquid crystal panels constituting the panel unit in a plan view.

As illustrated in FIG. 7, the lens module 1 includes the panel unit 111 and the conductive members 500. As described above with reference to FIG. 1, the panel unit 111 includes the first liquid crystal panel 10, the second liquid crystal panel 20, the third liquid crystal panel 30, and the fourth liquid crystal panel 40. The conductive members 500 include conductive members 510, 520, 530, and 540.

As illustrated in FIG. 7, the panel unit 111 has an octagonal shape in a plan view. Specifically, the panel unit 111 has a first side 71, a second side 72, a third side 73, a fourth side 74, a fifth side 75, a sixth side 76, a seventh side 77, and an eighth side 78 in a plan view. In the present disclosure, the outer shapes of the panel unit 111 and the liquid crystal panels 11 are not particularly limited to being octagonal, but may instead be any polygonal, circular, or elliptical shape. The conductive member 510 is disposed at the first side 71, the conductive member 520 is disposed at the third side 73, the conductive member 530 is disposed at the fifth side 75, and the conductive member 540 is disposed at the seventh side 77. The conductive members 500 are disposed at central portions of the respective sides of the panel unit 111 in a plan view. As illustrated in FIG. 8, each conductive member 500 is provided along the Z direction (first direction) on a side surface of the panel unit 111, continuously extending from the Z2-side end of the panel unit 111 to the Z1-side end thereof. The conductive members 500 may be made of, for example, silver (Ag), carbon (C), or the like, or a material containing these conductive materials. Each conductive member 500 is formed by, for example, applying a paste containing a conductive material to the side surface of the panel unit 111 and curing the paste.

As illustrated in FIG. 8, in the panel unit 111, the four liquid crystal panels 11 are stacked from the Z2 side to the Z1 side. Specifically, the first liquid crystal panel 10, the second liquid crystal panel 20, the third liquid crystal panel 30, and the fourth liquid crystal panel 40 are stacked from the Z2 side to the Z1 side. In the present embodiment, the liquid crystal panels 11 stacked in the Z direction (axial direction) are the four liquid crystal panels 11 having the same configuration. In other words, the first liquid crystal panel 10, the second liquid crystal panel 20, the third liquid crystal panel 30, and the fourth liquid crystal panel 40 have the same configuration but have different angles in the direction about the center axis AX in a plan view. The liquid crystal panels 11 adjacent to each other in the Z direction are bonded with an adhesive layer 57 therebetween. The first liquid crystal panel 10 includes a lower substrate S11, an upper substrate S12 disposed on the Z1 side relative to the lower substrate S11, and a liquid crystal layer 60 that is filled between the lower substrate S11 and the upper substrate S12. The second liquid crystal panel 20 includes a lower substrate S21, an upper substrate S22 disposed on the Z1 side relative to the lower substrate S21, and a liquid crystal layer 60 that is filled between the lower substrate S21 and the upper substrate S22. The third liquid crystal panel 30 includes a lower substrate S31, an upper substrate S32 disposed on the Z1 side relative to the lower substrate S31, and a liquid crystal layer 60 that is filled between the lower substrate S31 and the upper substrate S32. The fourth liquid crystal panel 40 includes a lower substrate S41, an upper substrate S42 disposed on the Z1 side relative to the lower substrate S41, and a liquid crystal layer 60 that is filled between the lower substrate S41 and the upper substrate S42.

### Configuration of Liquid Crystal Panel

Using, as an example, a configuration of the lower substrate S11 and the upper substrate S12 included in the first liquid crystal panel 10, the terminals and wirings of each substrate will be described below. As illustrated in FIG. 9, the lower substrate S11 of the first liquid crystal panel 10 has an octagonal shape. The lower substrate S11 has a first side 211, a second side 212, a third side 213, a fourth side 214, a fifth side 215, a sixth side 216, a seventh side 217, and an eighth side 218 in a plan view.

A first terminal 210 in the form of a wide strip is provided on the Y1 side in the lower substrate S11, and a first terminal 220 in the form of a wide strip is provided on the Y2 side in the lower substrate S11.

Specifically, the first terminal 210 is provided along edges of the second side 212, the third side 213, and the fourth side 214. The first terminal 210 includes a body portion 210a, an extended portion 210b, and an extended portion 210c. The body portion 210a is provided at the third side 213, the extended portion 210b is provided up to a middle portion of the second side 212, and the extended portion 210c is provided up to a middle portion of the fourth side 214.

A liquid crystal drive electrode 230 is coupled to the first terminal 210. The liquid crystal drive electrode 230 extends in the Y direction. Specifically, a plurality of the liquid crystal drive electrodes 230 are provided at intervals in the X direction.

The first terminal 220 is provided along edges of the sixth side 216, the seventh side 217, and the eighth side 218. The first terminal 220 includes a body portion 220a, an extended portion 220b, and an extended portion 220c. The body portion 220a is provided at the seventh side 217, the extended portion 220b is provided up to a middle portion of the eighth side 218, and the extended portion 220c is provided up to a middle portion of the sixth side 216.

A liquid crystal drive electrode 231 is coupled to the first terminal 220. The liquid crystal drive electrode 231 extends in the Y direction. Specifically, a plurality of the liquid crystal drive electrodes 231 are provided at intervals in the X direction. Each liquid crystal drive electrode 231 is disposed between the liquid crystal drive electrodes 230 adjacent to each other in the X direction. The liquid crystal drive electrodes 230 and 231 bend in substantially V shapes in a plan view as illustrated in FIG. 9. Specifically, the shapes are substantially V shapes that protrude toward the X1 side at a central portion in the Y direction. The liquid crystal drive electrodes 230 and 231 have shapes substantially symmetric with respect to the central portion in the Y direction, with the shapes on the Y1 and Y2 sides being substantially symmetrical. An effective region 81 is illustrated with a dashed and double-dotted line. An annular wall is formed by a seal material so as to form the effective region (not illustrated), and the upper and lower substrates are bonded by the seal material. The effective region is filled with a liquid crystal layer. The upper substrate is provided with an alignment film covering the liquid crystal drive electrodes 230 and 231. In FIG. 9, the alignment direction of the alignment film is illustrated with an arrow. The alignment film is made of, for example, polyimide (PI). The alignment film is provided to control the orientation of liquid crystal molecules when it is required that the liquid crystal molecules are aligned in one direction over a relatively large area.

As illustrated in FIG. 10, the upper substrate S12 of the first liquid crystal panel 10 has an octagonal shape. The upper substrate S12 includes a first side 311, a second side 312, a third side 313, a fourth side 314, a fifth side 315, a sixth side 316, a seventh side 317, and an eighth side 318 in a plan view.

A second terminal 310 in the form of a wide strip is provided on the X2 side in the upper substrate S12, and a second terminal 320 in the form of a wide strip is provided on the X1 side in the upper substrate S12.

Specifically, the second terminal 310 is provided along edges of the second side 312, the first side 311, and the eighth side 318. The second terminal 310 includes a body portion 310a, an extended portion 310b, and an extended portion 310c. The body portion 310a is provided at the first side 311, the extended portion 310b is provided up to a middle portion of the second side 312, and the extended portion 310c is provided up to a middle portion of the eighth side 318.

A liquid crystal drive electrode 330 is coupled to the second terminal 310. The liquid crystal drive electrode 330 extends in the X direction. Specifically, a plurality of the liquid crystal drive electrodes 330 are provided at intervals in the Y direction.

The second terminal 320 is provided along edges of the fourth side 314, the fifth side 315, and the sixth side 316. The second terminal 320 includes a body portion 320a, an extended portion 320b, and an extended portion 320c. The body portion 320a is provided at the fifth side 315, the extended portion 320b is provided up to a middle portion of the fourth side 314, and the extended portion 320c is provided up to a middle portion of the sixth side 316.

A liquid crystal drive electrode 331 is coupled to the second terminal 320. The liquid crystal drive electrode 331 extends in the X direction. Specifically, a plurality of the liquid crystal drive electrodes 331 are provided at intervals in the Y direction. Each liquid crystal drive electrode 331 is disposed between the liquid crystal drive electrodes 330 adjacent to each other in the Y direction. The liquid crystal drive electrodes 330 and 331 bend in substantially V shapes in a plan view as illustrated in FIG. 10. Specifically, the shapes are substantially V shapes that protrude toward the Y1 side at a central portion in the X direction. The liquid crystal drive electrodes 330 and 331 have shapes substantially symmetric with respect to the central portion in the X direction, with the shapes on the X1 and X2 sides being substantially symmetrical. The effective region 81 is illustrated with a dashed and double-dotted line. The lower substrate is provided with an alignment film covering the liquid crystal drive electrodes 330 and 331. In FIG. 10, the alignment direction of the alignment film is illustrated with an arrow.

In the present embodiment, for example, a positive-type twisted nematic liquid crystal (TN liquid crystal) is used as each liquid crystal layer 60, and the long axes of the liquid crystal molecules are aligned in the same direction as the alignment directions of the alignment films. In each of the first liquid crystal panel 10, the second liquid crystal panel 20, the third liquid crystal panel 30, and the fourth liquid crystal panel 40, the alignment direction of the alignment film of the lower substrate intersects the alignment direction of the alignment film of the upper substrate. Accordingly, the liquid crystal molecules of the liquid crystal layer 60 do not receive influence of the external electric field and are aligned such that their long-axis directions are twisted by 90° from the alignment film of the lower substrate to the alignment film of the upper substrate.

The orientations of the lower and upper substrates in the first liquid crystal panel 10, the second liquid crystal panel 20, the third liquid crystal panel 30, and the fourth liquid crystal panel 40 are as illustrated with unfilled arrows “a” in FIG. 11. In addition, dashed arrows “b” and solid arrows “c” are illustrated in FIG. 11. Each dashed arrow “b” indicates an electrode extending direction in which the corresponding liquid crystal drive electrodes extend. Each solid arrow “c” indicates an initial alignment direction of the corresponding alignment films. The initial alignment direction (arrow “c”) of the alignment films intersects the electrode extending direction (arrow “b”). The following sequentially describes arrows “a”, “b”, and “c”.

The orientations and angles of arrows “a” illustrated in the lower and upper substrates indicate orientations and rotation angles after rotation in the direction about the center axis AX relative to the orientations of the lower substrate S11 in FIG. 9 and the upper substrate S12 in FIG. 10. The following briefly describes the orientations of the substrates.

For example, the orientation of arrow “a” for the lower substrate S11 of the first liquid crystal panel 10 illustrated in FIG. 11 is the same as the orientation of the lower substrate S11 in FIG. 9. For example, the orientation of arrow “a” for the lower substrate S31 of the third liquid crystal panel 30 is an orientation rotated by 270° in the clockwise direction relative to the orientation of the lower substrate S11 in FIG. 9. Similarly, the orientation of arrow “a” for the upper substrate S12 of the first liquid crystal panel 10 illustrated in FIG. 11 is the same as the orientation of the upper substrate S12 in FIG. 10. For example, the orientation of arrow “a” for the upper substrate S42 of the fourth liquid crystal panel 40 is an orientation rotated by 90° in the clockwise direction relative to the orientation of the upper substrate S12 in FIG. 10. The following describes arrows “b”.

The electrode extending direction of the liquid crystal drive electrodes 230 and 231 in the lower substrate S11 in FIG. 9 is the Y direction. In FIG. 11, the electrode extending direction in the lower substrate S11 of the first liquid crystal panel 10 is the Y direction as illustrated with arrow “b”, and the electrode extending direction in the upper substrate S12 is the X direction as illustrated with arrow “b”. The electrode extending direction in the lower substrate S21 of the second liquid crystal panel 20 is the Y direction as illustrated with arrow “b”, and the electrode extending direction in the upper substrate S12 is the X direction as illustrated with arrow “b”. The electrode extending direction in the lower substrate S31 of the third liquid crystal panel 30 is the X direction as illustrated with arrow “b”, and the electrode extending direction in the upper substrate S32 is the Y direction as illustrated with arrow “b”. The electrode extending direction in the lower substrate S41 of the fourth liquid crystal panel 40 is the X direction as illustrated with arrow “b”, and the electrode extending direction in the upper substrate S42 is the Y direction as illustrated with arrow “b”. The following describes arrows “c”.

As described above, the initial alignment direction (arrow “c”) of the alignment films intersects the electrode extending direction (arrow “b”). Thus, as illustrated in FIG. 11, the initial alignment direction in the lower substrate S11 of the first liquid crystal panel 10 is the X direction as illustrated with arrow “c”, and the initial alignment direction in the upper substrate S12 is the Y direction as illustrated with arrow “c”. The initial alignment direction in the lower substrate S21 of the second liquid crystal panel 20 is the X direction as illustrated with arrow “c”, and the initial alignment direction in the upper substrate S12 is the Y direction as illustrated with arrow “c”. The initial alignment direction in the lower substrate S31 of the third liquid crystal panel 30 is the Y direction as illustrated with arrow “c”, and the initial alignment direction in the upper substrate S32 is the X direction as illustrated with arrow “c”. The initial alignment direction in the lower substrate S41 of the fourth liquid crystal panel 40 is the Y direction as illustrated with arrow “c”, and the initial alignment direction in the upper substrate S42 is the X direction as illustrated with arrow “c”. In FIGS. 9 and 10 as well, the initial alignment direction that intersects the electrode extending direction is illustrated with arrows “c”. In FIG. 11, the initial alignment direction of the alignment films and the electrode extending direction intersect at 90° in each substrate of each panel, but these may intersect at an angle other than 90°. For example, as illustrated in FIGS. 9 and 10, the liquid crystal drive electrodes and the initial alignment direction intersect at an angle smaller than 90°. In view of the necessity of suppressing, to some extent, rotation of the liquid crystal molecules along with electric field generation between adjacent liquid crystal drive electrodes due to the necessity of maintaining the twisted alignment state of the liquid crystal molecules between the upper and lower substrates before and after the electric field generation, it is preferable that the liquid crystal drive electrodes and the initial alignment direction on the same substrate intersect at an angle in the range of 80 to 90°.

In FIG. 11, terminals electrically coupled through one conductive member 500 among the first terminals 210 and 220 and the second terminals 310 and 320 illustrated in each substrate are classified into four kinds. Specifically, the four kinds are solid black, normal hatching, dotted hatching, and unfilled areas. In other words, terminals electrically coupled to the conductive member 510 provided at the first side 71 in the panel unit 111 illustrated in FIG. 7 are indicated by solid black in FIG. 11. Terminals electrically coupled to the conductive member 520 provided at the third side 73 are indicated by normal hatching. Terminals electrically coupled to the conductive member 530 provided at the fifth side 75 are indicated by dotted hatching. Terminals electrically coupled to the conductive member 540 provided at the seventh side 77 are indicated by unfilled areas.

Specifically, for example, the four solid-black terminals illustrated in FIG. 11 are electrically coupled through the same conductive member 500. More specifically, the conductive member 510 (refer to FIG. 7) is electrically coupled to the second terminal 310 on the upper substrate S12 of the first liquid crystal panel 10, the second terminal 320 on the upper substrate S22 of the second liquid crystal panel 20, the first terminal 210 on the lower substrate S31 of the third liquid crystal panel 30, and the first terminal 220 on the lower substrate S41 of the fourth liquid crystal panel 40; and these terminals are at the same potential.

The conductive member 520 (refer to FIG. 7) is electrically coupled to the first terminal 210 on the lower substrate S11 of the first liquid crystal panel 10, the first terminal 220 on the lower substrate S21 of the second liquid crystal panel 20, the second terminal 320 on the upper substrate S32 of the third liquid crystal panel 30, and the second terminal 310 on the upper substrate S42 of the fourth liquid crystal panel 40, and these terminals are at the same potential.

The conductive member 530 (refer to FIG. 7) is electrically coupled to the second terminal 320 on the upper substrate S12 of the first liquid crystal panel 10, the second terminal 310 on the upper substrate S22 of the second liquid crystal panel 20, the first terminal 220 on the lower substrate S31 of the third liquid crystal panel 30, and the first terminal 210 on the lower substrate S41 of the fourth liquid crystal panel 40, and these terminals are at the same potential.

The conductive member 540 (refer to FIG. 7) is electrically coupled to the first terminal 220 on the lower substrate S11 of the first liquid crystal panel 10, the first terminal 210 on the lower substrate S21 of the second liquid crystal panel 20, the second terminal 310 on the upper substrate S32 of the third liquid crystal panel 30, and the second terminal 320 on the upper substrate S42 of the fourth liquid crystal panel 40, and these terminals are at the same potential.

### Contact State Between Metal Plate and Conductive Member

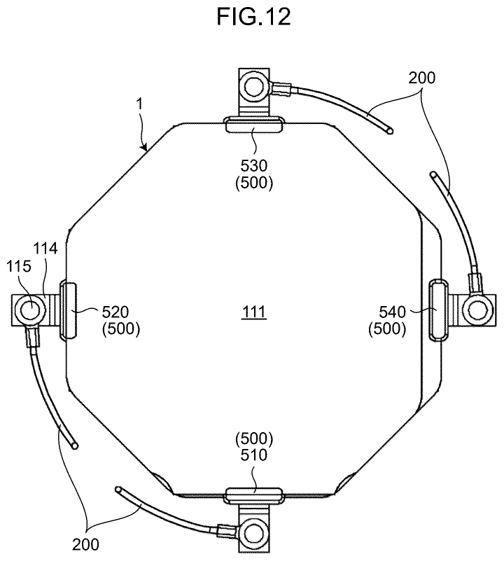

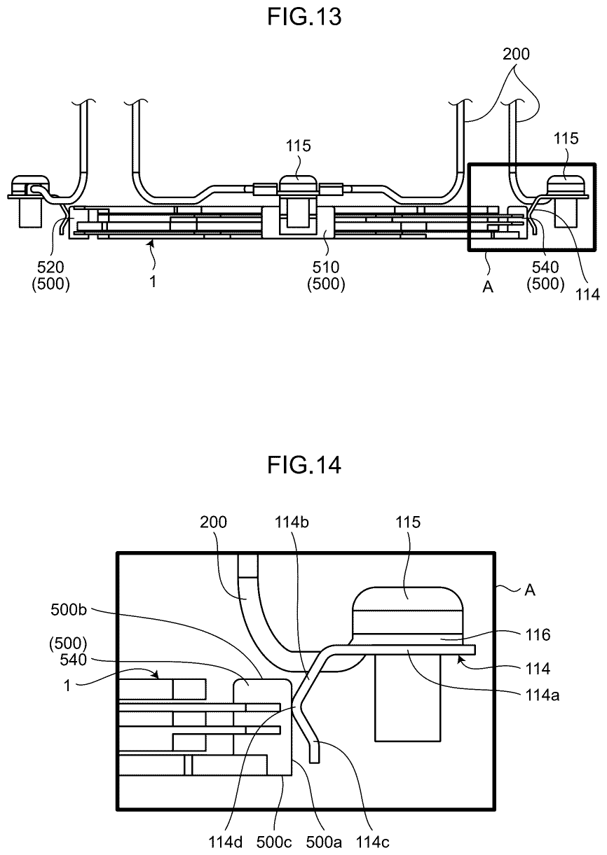

FIG. 12 is a plan view illustrating the lens module, the metal plates, and the wire harnesses. FIG. 13 is a side view of FIG. 12. FIG. 14 is an enlarged schematic diagram of part A in FIG. 13.

As illustrated in FIG. 12, the four conductive members 510, 520, 530, and 540 are provided at four places of the panel unit 111. The metal plates 114 (elastic members) are in contact with the respective conductive members 500, and the metal plates 114 are electrically coupled to the conductive members 500 by the contact. In addition, different wire harnesses 200 are electrically coupled to the four conductive members 510, 520, 530, and 540, respectively. As described above with reference to FIG. 11, terminals are electrically coupled to the conductive members 510, 520, 530, and 540. Thus, the potentials of the terminals coupled to the conductive members 510, 520, 530, and 540 can be made different from each other by inputting different potentials to the four wire harnesses 200, respectively.

As illustrated in FIGS. 13 and 14, each metal plate 114 includes a body portion 114a, a bent portion 114b, a bent portion 114c, and a contact portion 114d.

As illustrated in FIG. 14, the metal plate 114 is in contact with a side surface 500a of the conductive member 540. Specifically, the metal plate 114 is electrically coupled to the side surface 500a while being pressed (pressurized). Specific description is given below. As illustrated in FIG. 14, the body portion 114a has a flat plate shape extending in the Y direction. The bent portion 114b is obliquely bent from the Y1-side end of the body portion 114a toward the Y1 side and the Z1 side. The contact portion 114d is positioned at the Y1-side and Z1-side end of the bent portion 114b. The bent portion 114c is obliquely bent from the contact portion 114d toward the Y2 side and the Z1 side. The contact portion 114d has a shape that protrudes toward the Y1 side with respect to the metal plate 114. More specifically, the shape is a V shape that protrudes toward the Y1 side. Since the metal plate 114 is an elastic member, the bent portion 114b undergoes elastic deformation to elastically bend relative to the body portion 114a about its base end portion when the contact portion 114d is pressed. Accordingly, the contact portion 114d is constantly in contact with the side surface 500a of the conductive member 540 while being pressed. As described above, the metal plate 114 and the clasp 116 are attached to the corresponding boss 112c with the pin 115. In other words, the metal plate 114 and the clasp 116 are mounted to the boss 112c.

As described above, the illumination device 100 according to the first embodiment includes the lens module 1 including a plurality of liquid crystal panels 11, the holding member 2, and the held member 3 rotatably supporting the holding member 2. The lens module 1 is electrically coupled to the relay substrates 4 through the wire harnesses 200. The lens module 1 includes the panel unit 111 in which the liquid crystal panels 11 are stacked, and the conductive members 500 provided on the side surface of the panel unit 111 and extending in the Z direction (first direction). The metal plates 114 is in contact with the conductive members 500 so that the metal plates 114 (elastic members) having conductivity and the conductive members 500 are electrically coupled to each other.

The holding member 2 includes the lens module 1, the relay substrates 4, and the wire harnesses 200 electrically coupling the lens module 1 and the relay substrates 4. Accordingly, the lens module 1, the relay substrates 4, and the wire harnesses 200 rotate together when the holding member 2 rotates relative to the held member 3. Thus, according to the present embodiment, it is possible to reduce damage of couplers between the lens module 1 and the wire harnesses 200 that are wirings.

Moreover, in the present embodiment, the metal plates 114 is in contact with the conductive members 500, whereby the metal plates 114 and the conductive members 500 are electrically coupled to each other. Thus, in the present embodiment, it is possible to further reduce damage of couplers between the wire harnesses 200 and the lens module 1 when the lens module 1 is rotated, as compared to a case in which the metal plates 114 are fixed to the conductive members 500 by, for example, soldering or welding. In addition, as illustrated in FIG. 12, the four metal plates 114 can be fixed to the panel unit 111 from four directions in a plan view, and furthermore, the metal plates 114 can be easily removed from the panel unit 111.

The elastic members are the metal plates 114. Thus, it is possible to easily produce elastic members coupled to the conductive members 500 by, for example, bending the metal plates 114. Moreover, since the metal plates 114 are plate members, it is possible to achieve further weight reduction.

Each metal plate 114 includes the body portion 114a coupled to the corresponding wire harness 200, and the contact portion 114d coupled to the body portion 114a and in contact with the corresponding conductive member 500. In this manner, the contact portion 114d is in contact with the conductive member 500, whereby electric coupling between the contact portion 114d and the conductive member 500 can be more stably maintained.

The contact portion 114d of a metal plate 114A is in contact with the side surface 500a of the corresponding conductive member 500. Thus, electric coupling with the conductive member 500 can be more stably maintained even when the position of the contact portion 114d has shifted in the Z direction, which is a direction along the side surface 500a.

The lens module 1 includes the panel unit 111 in which the liquid crystal panels 11 are stacked in the Z direction (first direction), and the conductive members 500 provided on the side surface of the panel unit 111 and extending in the Z direction. The metal plates 114 electrically coupled to the wire harnesses 200 and having conductivity are in contact with the conductive members 500. Thus, in the present embodiment, it is possible to further reduce damage of couplers between the wire harnesses 200 and the lens module 1 when the lens module 1 is rotated, as compared to a case in which the metal plates 114 are fixed to the conductive members 500 by, for example, soldering or welding.

### First Modification

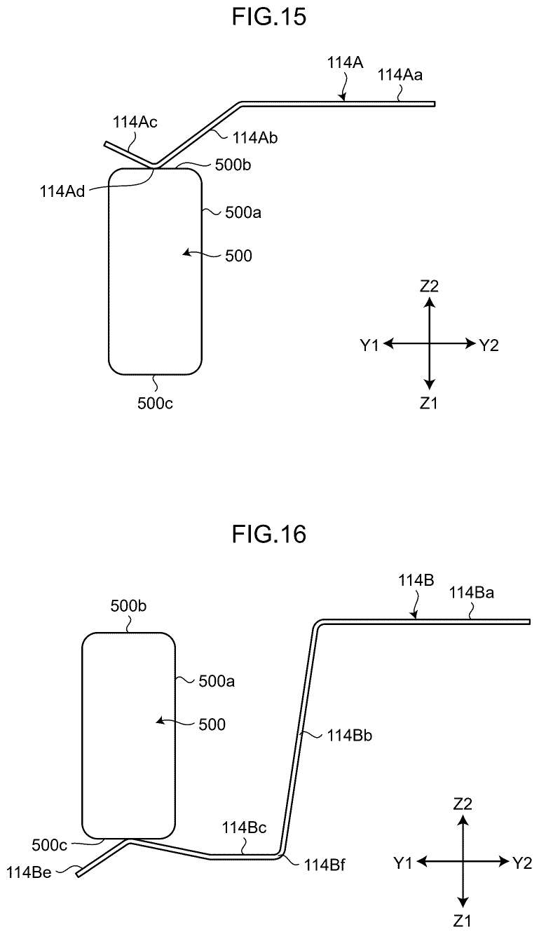

The following describes a first modification. FIG. 15 is a schematic diagram illustrating a metal plate and a conductive member in the first modification. In the first modification, the shape of each metal plate 114A and a portion of a conductive member 500 where a contact portion 114Ad contacts are different from those in the first embodiment. Detailed description is given below.

Each metal plate 114A according to the first modification includes a body portion 114Aa, a bent portion 114Ab, a bent portion 114Ac, and the contact portion 114Ad.

As illustrated in FIG. 15, the contact portion 114Ad of the metal plate 114A is contact with an upper surface 500b (end face) of the conductive member 500. Specific description is given below. As illustrated in FIG. 15, the body portion 114Aa has a flat plate shape extending in the Y direction. The bent portion 114Ab is obliquely bent from the Y1-side end of the body portion 114Aa toward the Y1 side and the Z1 side. The contact portion 114Ad is positioned at the Y1-side and Z1-side end of the bent portion 114Ab. The bent portion 114Ac is obliquely bent from the contact portion 114Ad toward the Y1 side and the Z2 side. The contact portion 114Ad has a shape that protrudes toward the Z1 side with respect to the metal plate 114A. More specifically, the shape is a V shape that protrudes toward the Z1 side. Since the metal plate 114A is an elastic member, the bent portion 114Ab undergoes elastic deformation to elastically bend relative to the body portion 114Aa when the contact portion 114Ad is pressed. Accordingly, the contact portion 114Ad is constantly in contact with the upper surface 500b of the conductive member 500.

As described above, in the first modification, the contact portion 114Ad of the metal plate 114A is in contact with the upper surface 500b (end face) of the conductive member 500. Thus, electric coupling between the contact portion 114Ad and the conductive member 500 can be more stably maintained even when the position of the conductive member 500 in the Z direction has changed.

### Second Modification

The following describes a second modification. FIG. 16 is a schematic diagram illustrating a metal plate and a conductive member in the second modification.

In the second modification, the shape of each metal plate 114B and a portion of a conductive member 540 where a contact portion 114Bd contacts are different from those in the first embodiment. Detailed description is given below.

Each metal plate 114B according to the second modification includes a body portion 114Ba, a bent portion 114Bb, a bent portion 114Bc, the contact portion 114Bd, and a bent portion 114Be.

As illustrated in FIG. 16, the contact portion 114Bd of the metal plates 114B is in contact with a lower surface 500c (end face) of the conductive member 500. Specific description is given below. As illustrated in FIG. 16, the body portion 114Ba has a flat plate shape extending in the Y direction. The bent portion 114Bb is obliquely bent from the Y1-side end of the body portion 114Ba toward the Y1 side and the Z1 side. The bent portion 114Bc PK extends from an end 114Bf toward the Y1 side. The contact portion 114Bd is positioned at the Z2-side end of the bent portion 114Bc. The bent portion 114Be is obliquely bent from the contact portion 114Bd toward the Y1 side and the Z1 side. The contact portion 114Bd has a shape that protrudes toward the Z2 side. More specifically, the shape is a V shape that protrudes toward the Z2 side. Since the metal plate 114B is an elastic member, the bent portions 114Bb and 114Bc undergo elastic deformation to elastically bend relative to the body portion 114Ba when the contact portion 114Bd is pressed. Accordingly, the contact portion 114Bd is constantly in contact with the lower surface 500c of the conductive member 500.

As described above, in the second modification, the contact portion 114Bd of the metal plate 114B is in contact with the lower surface 500c (end face) of the conductive member 500. Thus, electric coupling between the contact portion 114Bd and the conductive member 500 can be more stably maintained even when the position of the conductive member 500 in the Z direction has changed.

### Second Embodiment

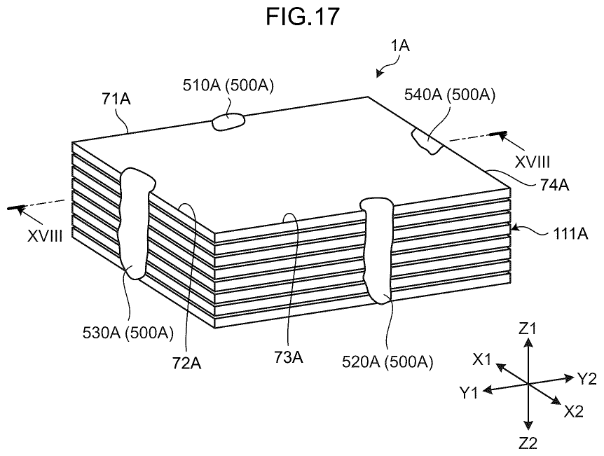

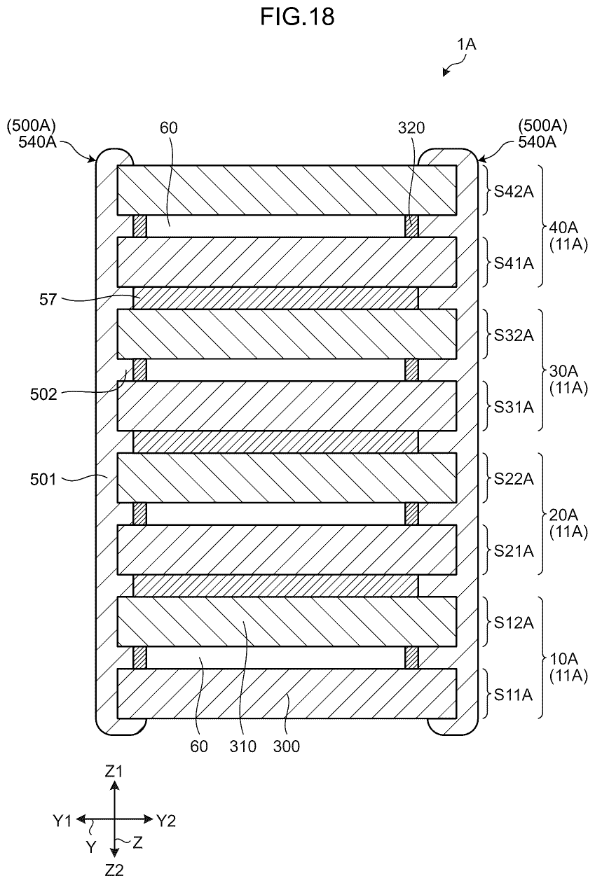

The following describes an illumination device according to a second embodiment. FIG. 17 is a perspective view of a lens module according to the second embodiment. FIG. 18 is a sectional view of FIG. 17.

### Configuration of Lens Module

As illustrated in FIG. 17, a panel unit 111A has a rectangular shape in a plan view. Specifically, the panel unit 111A includes a first side 71A, a second side 72A, a third side 73A, and a fourth side 74A in a plan view. Conductive members 500A include conductive members 510A, 520A, 530A, and 540A. The conductive member 510A is disposed at the first side 71A, the conductive member 530A is disposed at the second side 72A, the conductive member 520A is disposed at the third side 73A, and the conductive member 540A is disposed at the fourth side 74A. The conductive members 500A are disposed at a longitudinal central portion of each side of the panel unit 111A in a plan view. As illustrated in FIG. 17, each conductive member 500A is provided along the Z direction (first direction) on a side surface of the panel unit 111A, continuously extending from the Z2-side end of the panel unit 111A to the Z1-side end thereof. The material of the conductive members 500A is the same as that of the conductive members 500.

Liquid crystal panels 11A are, for example, a first liquid crystal panel 10A, a second liquid crystal panel 20A, a third liquid crystal panel 30A, and a fourth liquid crystal panel 40A. As illustrated in FIG. 18, in a lens module 1A, the four liquid crystal panels 11A are stacked from the Z2 side to the Z1 side. Specifically, the first liquid crystal panel 10A, the second liquid crystal panel 20A, the third liquid crystal panel 30A, and the fourth liquid crystal panel 40A are stacked in the stated order from the Z2 side toward the Z1 side. In the present embodiment, the liquid crystal panels 11A stacked in the Z direction (axial direction) are the four liquid crystal panels having the same configuration. In other words, the first liquid crystal panel 10A, the second liquid crystal panel 20A, the third liquid crystal panel 30A, and the fourth liquid crystal panel 40A have the same configuration but have different angles in the direction about the center axis AX in a plan view. The staking relation of the liquid crystal panels may be the same as that in the first embodiment, and a configuration may be employed in which all of the liquid crystal panels are simply stacked without rotating any of the liquid crystal panels.

As described above, in the second embodiment as well, metal plates electrically coupled to wire harnesses and having conductivity are in contact with the conductive members 500A. Thus, in the present embodiment, it is possible to further reduce damage of couplers between the wire harnesses and the lens module 1A when the lens module 1A is rotated, as compared to an aspect in which the metal plate 114A are fixed to the conductive members 500A by, for example, soldering or welding.

What is claimed is:

1. An illumination device comprising:
a holding member having a center axis extending in a first direction;
a held member supporting the holding member so as to allow the holding member to rotate in a direction about the center axis;
a lens module mounted on the holding member and including a plurality of liquid crystal panels;
a relay substrate mounted on the holding member and electrically coupled to the lens module through a wire harness;
a light source mounted on the held member; and
a control substrate mounted on the held member and electrically coupled to the relay substrate, wherein the lens module includes
a panel unit in which the liquid crystal panels are stacked in the first direction, and
a conductive member provided on a side surface of the panel unit and extending in the first direction,
the wire harness is electrically coupled to an elastic member having conductivity, and
the elastic member is in contact with the conductive member so that the elastic member and the conductive member are electrically coupled to each other.

2. The illumination device according to claim 1, wherein the elastic member is a metal plate.

3. The illumination device according to claim 2, wherein the metal plate includes
a body portion coupled to the wire harness, and
a contact portion coupled to the body portion and in contact with the conductive member.

4. The illumination device according to claim 3, wherein the contact portion is in contact with a side surface of the conductive member.

5. The illumination device according to claim 3, wherein the contact portion is in contact with an end face of the conductive member in the first direction.

6. A lens module comprising:
a panel unit in which a plurality of liquid crystal panels are stacked in a first direction; and
a conductive member provided on a side surface of the panel unit and extending in the first direction,
wherein an elastic member electrically coupled to a wire harness and having conductivity is in contact with the conductive member.
